(19) United States
(12) Patent Application Publication
(10) Pub. No.: US 2006/0219920 A1
(43) Pub. Date: Oct. 5, 2006

(54) IR Camera

(76) Inventors: Jonas Wijk, Nacka (SE); Ayse Koylouglu, Spanga (SE)

Correspondence Address: ALBIHNS STOCKHOLM AB, BOX 5581, LINNEGATAN 2, SE-114 85 STOCKHOLM; SWEDENn, STOCKHOLM, SE

(21) Appl. No.: 10/907,529

(22) Filed: Apr. 5, 2005

(51) Int. Cl. G01J 5/02

(52) U.S. Cl. 250/332

(57) ABSTRACT

An IR camera (1) for use within a predetermined scene temperature range comprises a focal plane array (7), and a signal processing device (9) arranged to receive an incoming signal from pixels of the focal plane array (7). The signal processing device (9) is arranged, for each image, to perform the following steps; identify any pixels of the focal plane array (7) for which the incoming signal, anywhere inside the scene temperature range, is equal to or larger than the predetermined maximum value, or equal to or less than the predetermined minimum value, replace the value of each element thus identified with a replacement value based on the value of at least one neighbouring element. By performing this in real time instead of permanently disabling any element that reaches the maximum or minimum value within the scene temperature range of the camera, the quality of the image is improved.

### TECHNICAL FIELD

The present invention relates to an IR camera as defined in the preamble of claim 1. It also relates to a method pertaining to an IR camera as defined in the preamble of claim 5.

### BACKGROUND AND PRIOR ART

IR cameras, or thermal cameras, register infrared (IR) radiation emitted from an object or an area. Typically, in IR cameras the incoming IR radiation is focused onto a focal plane array comprising an array of pixels, each registering the incoming radiation from a point, or small area of the object. Each pixel then converts then incoming IR radiation to an electrical signal, such as a voltage signal or a current signal.

A signal processing device calculates the corresponding temperature for each pixel, and presents a picture where each temperature is represented by a colour. In this way, the temperature in different parts of the objects is displayed in a picture.

The magnitude of the electrical signal generated by the different pixels as a result of a particular IR radiation, will vary between the pixels, as will be discussed below in connection with FIGS. 1 and 2. Some pixels will generate a higher voltage and some a lower voltage than the average. Therefore, the pixel data are processed and the deviation for each pixel is compensated for so that the same amount of IR radiation will be interpreted in the same way by all pixels.

Typically the analogue voltage from each pixel is converted by an AD converter to a digital number between a minimum value and a maximum value, for example between 0 and 65 535 (for a 16-bit AD converter). This digital number is input to the signal processing device. A seen temperature range for the camera is defined, that is, the temperature range in which the camera is supposed to function, for example between 0° C. and 100° C. All pixels are tested within this range to ensure that they work throughout the complete range.

In prior art cameras any pixel that assumes the maximum (e.g. 65 535) or minimum (e.g. 0) value within this operational range is permanently disabled and defined as a non-operating pixel (NOP). Values from neighbour pixels are then used to replace these NOPs. This is to avoid a pixel showing a misleading value.

If several neighbouring pixels assume the maximum or minimum value within the operational range there is a risk that the quality of the image will be insufficient in the area where few pixels are operating.

### OBJECT OF THE INVENTION

It is therefore an object of the invention to improve image quality of IR images presented by an IR camera.

### SUMMARY OF THE INVENTION

This object is achieved according to the invention by an IR camera comprising a focal plane array, said focal plane array comprising an array of elements for registering incoming IR radiation from an object, and a signal processing device arranged to receive an incoming signal from each element indicative of the incoming IR radiation in said elements, said incoming signal having a predetermined minimum value and a predetermined maximum value, and to process said incoming signal from each of the elements to obtain a temperature value in order to generate a thermal image of the object, said camera having a predetermined scene temperature range and being characterized in that said signal processing device is arranged, for each image, to perform the following steps
identify any elements of the focal plane array for which the incoming signal is equal to or larger than the predetermined maximum value, or equal to or less than the predetermined minimum value,
replace the value of each element thus identified with a replacement value based on the value of at least one neighbouring element.

The object is also achieved by a method for use with an IR camera having a predetermined scene temperature range and having a focal plane array comprising a plurality of pixels, for registering incoming IR radiation from an object, said method comprising the steps of
converting incoming IR radiation in each pixel to a level signal having a predefined minimum value and a predefined maximum value,
using said level signal from each of the plurality of pixels to obtain a temperature value in order to generate a thermal image, said method being characterized in that it comprises the steps of:
identifying any pixels whose digital signal throughout the scene temperature range is equal to or larger than the predetermined maximum value, or equal to or less than the predetermined minimum value
for the pixels thus identified, replacing the value of each element thus identified with a replacement value based on the value of at least one neighbouring element.

In this way, each pixel of the focal plane array is used and treated as operating for as long as it generates a correct value and is only replaced and treated as NOP in cases when it actually generates the predetermined maximum or minimum value, indicating that it has reached its limit and may at the moment be generating an incorrect value. When the value generated is again within the acceptable range, the actual value generated by the pixel is used again.

In prior art cameras, pixels that will generate the predetermined maximum or minimum value within the scene temperature range has been disabled permanently, that is, values from neighbour pixels are used to replace them regardless of their value in any given moment.

The elements of the focal plane array are preferably arranged to convert the incoming IR radiation to a voltage signal and further comprising means for converting the voltage signal to a digital signal representing the incoming signal.

The signal processing device may be arranged to identify saturated pixel elements in real time, and have them replaced from neighboring elements values only when they are actually saturated, that is, when they have a value equal to the minimum or maximum value. The replacement value may be selected from one neighbouring pixel or the values of several pixels in the vicinity of the pixel that is to be replaced may be weighted together.

### BRIEF DESCRIPTION OF THE DRAWINGS

The present invention will be described in more detail in the following, with reference to the appended drawings, in which:

FIG. 1A illustrates by way of example the distribution of the signals from each element of the focal plane array generating voltage signals when looking at 30 C.

FIG. 1B illustrates by way of example the distribution of the signals from each element of the focal plane array generating voltage signals when looking at 100 C.

FIG. 2 shows an IR camera according to the invention

FIG. 3 illustrates schematically the method according to the invention.

### DETAILED DESCRIPTION OF EMBODIMENTS

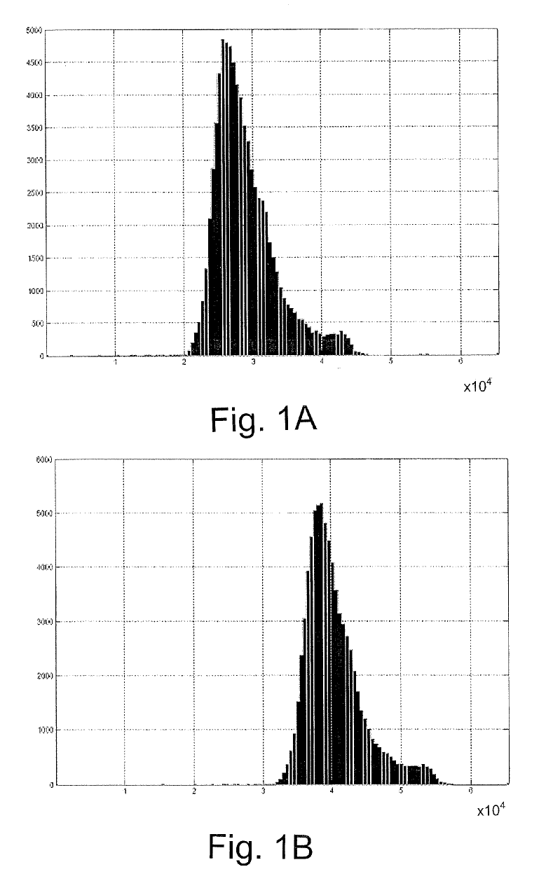

FIG. 1A illustrates the distribution of the signals from the pixels when looking at 30° C. FIG. 1B illustrates the distribution of the signals from each pixel when looking at 100° C. As explained above, the magnitude of the electrical signal generated by the different pixels as a result of a particular IR radiation, will vary between the pixels. FIGS. 1A and 1B relate to focal plane arrays generating voltage signals. As the skilled person knows, a similar distribution occurs in focal plane arrays generating other kinds of signals, such as current or digital signals. The horizontal axis represents the signal voltage values (AD converted). These digital values are input to the signal processing device. The vertical axis represents the number of pixels that generate each digital value. As can be seen on the horizontal axis the digital value varies between 0 and 65535. Note that the histogram shape is almost the same against 30° C. and 100° C., except for an offset shift to higher digital values at the higher temperature.

As can be seen, the two curves have virtually the same shape. However, deviations do exist and must be compensated for. The deviation for each pixel is compensated in the signal processing device, so that the same amount of incoming radiation generates the same result for each pixel.

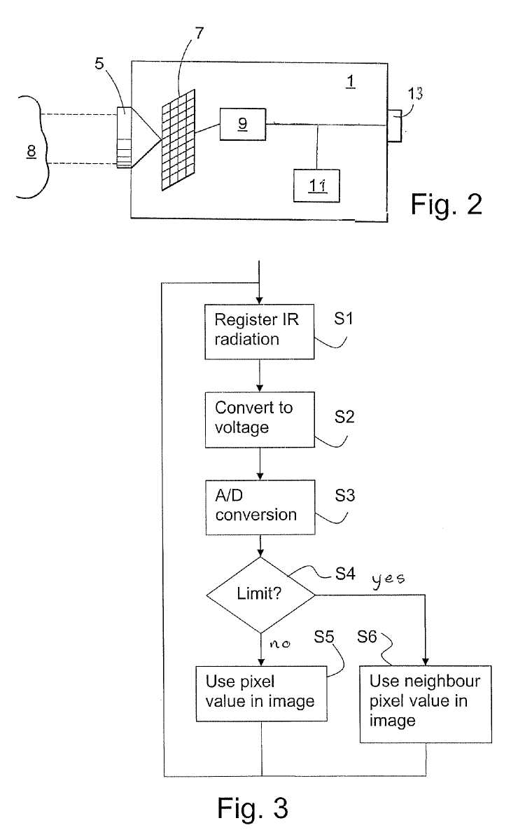

FIG. 2 illustrates schematically an IR camera 1 according to the invention. The camera comprises optical elements 5 for focusing incoming IR radiation onto a focal plane array 7 comprising a number of elements, or pixels. Incoming IR radiation from an object 8 is focused by the optics onto the focal plane array. A signal processing device 9 receives a digital signal from each pixel and processes the digital signals received for all the pixels to generate an image. As explained above, the deviation of each pixel is compensated for, and the image is coloured according to a colouring scheme where each colour or shade represents a particular temperature or temperature range. The skilled person is familiar with how to generate images indicative of temperature from the signals received from the focal plane array 7.

The A/D conversion may be performed in the focal plane array itself, so that a digital value is provided directly from the detector. Alternatively an A/D converter may be arranged between the focal plane array 7 and the signal processing device 9. Of course, the A/D conversion may also be performed by the signal processing device 9 before any other signal processing.

As is common in the art, a predefined minimum and a predefined maximum AD converted signal value have been defined for the signal generated by each pixel. The minimum and maximum value may be, for example, 0 and 65 535 respectively. Also, a working range in terms of scene temperatures has been defined for the camera, for example, between 0° C. and 100° C.

Some of the pixels will generate the value 0 for some scene temperatures above 0° C., for example, for all temperatures below 5° C., and some of the pixels will generate the value 65 535 for some temperatures below 100° C., for example, for all temperatures above 90° C. The exact values, of course, vary between different pixels.

According to the invention the processing device 9 is arranged to handle this by replacing pixels whose value equals 0 or 65535 with a value calculated from neighbouring pixels. This is performed in real time and is done every time a pixel value is being read. When the pixel again indicates a value between 0 and 65 535 the actual temperature value indicated by the pixel is used.

Of course, the functions of the signal processing device 9 can be divided between several processing units. The camera preferably also comprises a memory unit 11 for storing images, a viewer 13 for presenting an image directly to an operator and at least one output for presenting the images on a screen and/or storing image data in a computer. The camera of the invention may also comprise any other functions used in an IR camera, such as sound recording. The skilled person is familiar with how to implement such functions and they are therefore not discussed in any detail here, since they are not related to the inventive idea.

FIG. 3 illustrates schematically the method according to the invention. The method is preferably carried out in real time, that is, continuously while sampling images. In step S1 incoming IR radiation is registered in one pixel of the focal plane array 7. In step S2 the focal plane array converts the radiation to a voltage signal as is common in the art. In step S3 an A/D conversion takes place, to convert the voltage signal to a digital signal between a minimum and a maximum value, for example, 0 and 65 535. In step S4 the signal processing means 9 checks if the digital signal equals the minimum or maximum value. If the answer is no, in step S5 the signal processing means 9 uses the value of the digital signal when generating the thermal image. If the answer is yes, in step S6 the signal processing means 9 uses another digital value calculated from neighbouring pixels when generating the thermal image. The method then commences again from step S1.

The skilled person is familiar with several different ways of calculating the replacement value. For example, one neighbouring pixel having a value different from the maximum and minimum values may be selected. Alternatively, the values of several pixels in the vicinity of the pixel that is to be replaced can be weighted together.

What is claimed is:

1. An IR camera (1) comprising a focal plane array (7), said focal plane array (7) comprising an array of elements for registering incoming IR radiation from an object, and a signal processing device (9) arranged to receive an incoming signal from each element indicative of the incoming IR radiation in said elements, said incoming signal having a predetermined minimum value and a predetermined maximum value, and to process said incoming signal from each of the elements to obtain a temperature value in order to generate a thermal image of the object, said camera (1) having a predetermined scene temperature range and being characterized in that said signal processing device (9) is arranged, for each image, to perform the following steps
identify any elements of the focal plane array (7) for which the incoming signal, anywhere inside the scene temperature range, is equal to or larger than the predetermined maximum value, or equal to or less than the predetermined minimum value,
replace the value of each element thus identified with a replacement value based on the value of at least one neighbouring element.

2. An IR camera according to claim 1, wherein the elements of the focal plane array (7) are arranged to convert the incoming IR radiation to a voltage signal and further comprising means for converting the voltage signal to a digital signal representing the incoming signal.

3. An IR camera according to claim 1 or 2, wherein the signal processing device (9) is arranged to determine the replacement value for a particular identified element as the value of a neighbouring element of the identified element.

4. An IR camera according to claim 1 or 2, wherein the signal processing device (9) is arranged to determine the replacement value for a particular identified element on the basis of at least two neighbouring elements of the element.

5. A method for use with an IR camera having a predetermined scene temperature range and having a focal plane array comprising a plurality of pixels, for registering incoming IR radiation from an object, said method comprising the steps of
converting incoming IR radiation in each pixel to a level signal having a predefined minimum value and a predefined maximum value,
using said level signal from each of the plurality of pixels to obtain a temperature value in order to generate a thermal image, said method being characterized in that it comprises the steps of:
identifying pixels whose incoming signal, anywhere inside the scene temperature range, is equal to or larger than the predetermined maximum value, or equal to or less than the predetermined minimum value
for the pixels thus identified, replacing the value of each element thus identified with a replacement value based on the value of at least one neighbouring element.

6. A method according to claim 5, comprising the steps of converting the incoming IR radiation in each element to a voltage signal and converting the voltage signal to a digital signal representing the level of incoming IR radiation.

7. A method according to claim 5 or 6, wherein the replacement value for a particular identified element is determined as the value of a neighbouring element of the identified element.

8. A method according to claim 5 or 6, wherein the replacement value for a particular identified element is determined on the basis of at least two neighbouring elements of the element.
